(19) United States
(12) Patent Application Publication
(10) Pub. No.: US 2013/0046744 A1
(43) Pub. Date: Feb. 21, 2013

(54) SOCIAL KNOWLEDGEBASE

(71) Applicants: Vinay Krishnaswamy, Woodinville, WA (US); Ravipal Soin, Kirkland, WA (US); Anna Latuskiewicz, Kirkland, WA (US)

(72) Inventors: Vinay Krishnaswamy, Woodinville, WA (US); Ravipal Soin, Kirkland, WA (US); Anna Latuskiewicz, Kirkland, WA (US)

(21) Appl. No.: 13/564,655

(22) Filed: Aug. 1, 2012

Related U.S. Application Data
(60) Provisional application No. 61/525,147, filed on Aug. 18, 2011.

(51) Int. Cl. G06F 17/30

(52) U.S. Cl. 707/705; 707/E17.001

(57) ABSTRACT

The instant application discloses, among other things, ways to allow people to obtain information from sources that their friends may trust, and to cross-validate sources so that confidence may be increased.

### FIELD

This disclosure relates to a Social Knowledgebase.

### BACKGROUND

In many cases, the production and use of knowledge is a collective enterprise, and communication between its participants may be a bottleneck. Some of the costs of this bottleneck are duplicated work, misdirected work, slower progress, and suboptimal decisions for lack of knowledge that is actually available.

Additionally, people using the internet to obtain knowledge may question the veracity of some sources. Or worse, not question them, and hence receive incorrect information.

### SUMMARY

Reading is an immersive activity that requires uninterrupted visual flow to enable the best possible reading experience to approximate, equal or better the experience of a paper book on a digital device. It is possible to better the experience of a paper device by allowing the user to choose text and look up dictionary definitions. An even better experience is to also allow deeper knowledge to be provided to the user about the selection. This better experience can be further enhanced if that information is further surfaced from the user's social graph and people the user or system comes to trust over time for a particular topic. People may trust information obtained from people they know and trust, and may sometimes depend on different sets of people for different types of knowledge. Enhancing a person's social network to provide create knowledge is thus a natural extension.

The instant application discloses, among other things, ways to allow people to obtain information from sources that their friends may trust, and to cross-validate sources so that confidence may be increased.

### BRIEF DESCRIPTION OF THE DRAWINGS

FIG. 1 is an example of a system on which a Social Knowledgebase may be operated.

FIG. 2 illustrates relationships between various parts of a Social Knowledgebase.

FIG. 3 provides an example of Metadata about knowledge which may be stored in a Social Knowledgebase.

FIG. 4 illustrates how content may be promoted to knowledge according to one embodiment.

FIG. 5 illustrates a component diagram of a Computing Device according to one embodiment.

Like reference numerals indicate like elements in the drawings. Elements in the drawings are not drawn to scale unless otherwise indicated.

### DETAILED DESCRIPTION

Viewing content, whether reading a book or reading a blog, is an immersive activity that requires uninterrupted visual flow to enable the best possible experience to approximate, equal or better the experience of a paper book on a digital device. It is possible to better the experience of a paper device by allowing the user to choose text and look up dictionary definitions. An even better experience is to also allow deeper knowledge to be provided to the user about the selection. This better experience can be further enhanced if that information is further surfaced from the user's social graph and people the user or system comes to trust over time for a particular topic. A social knowledgebase may include access to various knowledge sources, such as wikipedia.org, freebase.com, emails, email contacts, and other content created by the user or other users, including books, magazines, and Facebook postings, and other content sources; metadata about the knowledge, which may include context and user recommendations; related data; knowledge built up by users of the social knowledgebase; references within content; an ability to search by keywords or categories; an ability to obtain knowledge based on metrics, such as popularity, user profiles, relevance to the topic itself, or other metrics; access to social networks, such as FACEBOOK, GOOGLE+, LinkedIn, and other social networks; and an application programming interface (API) to allow the retrieval and publication of knowledge. Content and knowledge may also be surfaced from enterprise resources, including but not limited to email, software applications, blogs, and websites. Any resource surfacing content or knowledge may be referred to as a social network.

Once content has been created, it may be discovered through various ways, including, but not limited to, document keywords, full-text parsing, or metadata about a document or the knowledge.

One having skill in the art will recognize that many sources may be used to obtain knowledge.

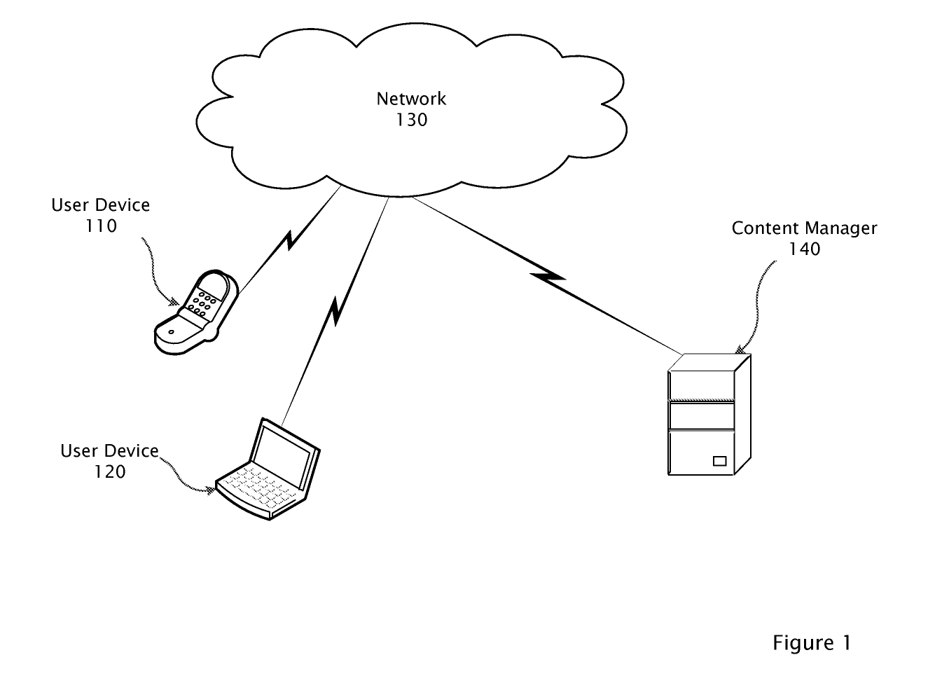

FIG. 1 is an example of a system on which a Social Knowledgebase may be operated. User Device 110 or User Device 120 may be used to read information with which a Social Knowledgebase is associated. Content Manager 140 may store information relevant to a Social Knowledgebase, allowing User Devices 110, 120 to display meta-information about an article, photo, video, or other content that may be viewed. Network 130 may be any way to transfer data between User Devices 11, 120 and Content Manager 140, including but not limited to, a local area network, a wide area network, the internet, direct wiring, wireless, shared storage devices, or portable storage devices that may be connected to various devices at different times.

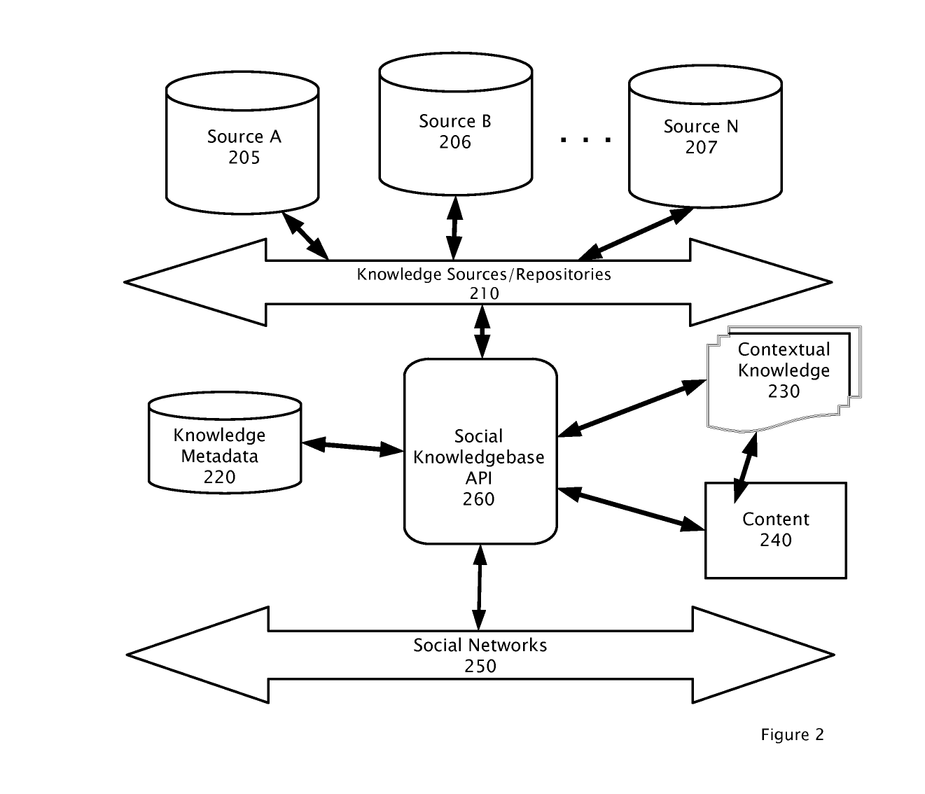

FIG. 2 illustrates relationships between various parts of a Social Knowledgebase. In this example, Sources A 205, B 206, and N 207 may be wikipedia.org, freebase.com, and imdb.com respectively. These may be accessed via Knowledge Sources/Repository 210 part, which may provide a consistent interface for a Social Interface Application Programming Interface (API) 260 to access the Sources 205, 206, 207. One skilled in the art will recognize that many Sources may be accessed through Social Knowledgebase API 260.

Social Knowledgebase API 260 may also interact with various Social Networks 250, including, for example, Facebook, MySpace, LinkedIn, Pinterest, or any other forums where a user may interact socially with other individuals or groups.

A user may create Contextual Knowledge 230 so that it may resurface during access of relevant content.

A user may be reading or editing and may select text, image, audio or video, to form a knowledge context. For example, existing knowledge may be shown as a stream with the most relevant knowledge first. The knowledge shown may be a combination of knowledge created by one or more users as well as knowledge that exists in sources described in a knowledge base.

The user may also add knowledge to the knowledge context from a source or by adding text, images, video, audio or other media, including the selection itself, where the keywords and categories for the knowledge may be based on the selection itself.

The user may vote for relevance of displayed knowledge in the knowledge context that it is shown in, which may affect whether that knowledge will show up in later displays for that knowledge context.

The user may also choose to see relevant ads within the context where relevance can be established by the context and other attributes such as keyword relevance and location, if a location attribute is set within the knowledge.

The user may choose to download or purchase content to which is indicated by a knowledge context.

Promotion of content to knowledge may take place by highlighting or selecting the content and then clicking a “promote to knowledge” button.

Any content a user views may be promoted to knowledge. Once content has been promoted to knowledge, it may resurface as Contextual Knowledge 230, which may be associated with Content 240. Contextual Knowledge 230 may, for example, be surfaced based on what a user is reading, highlighting, or creating. Knowledge may also be a source of content when creating content.

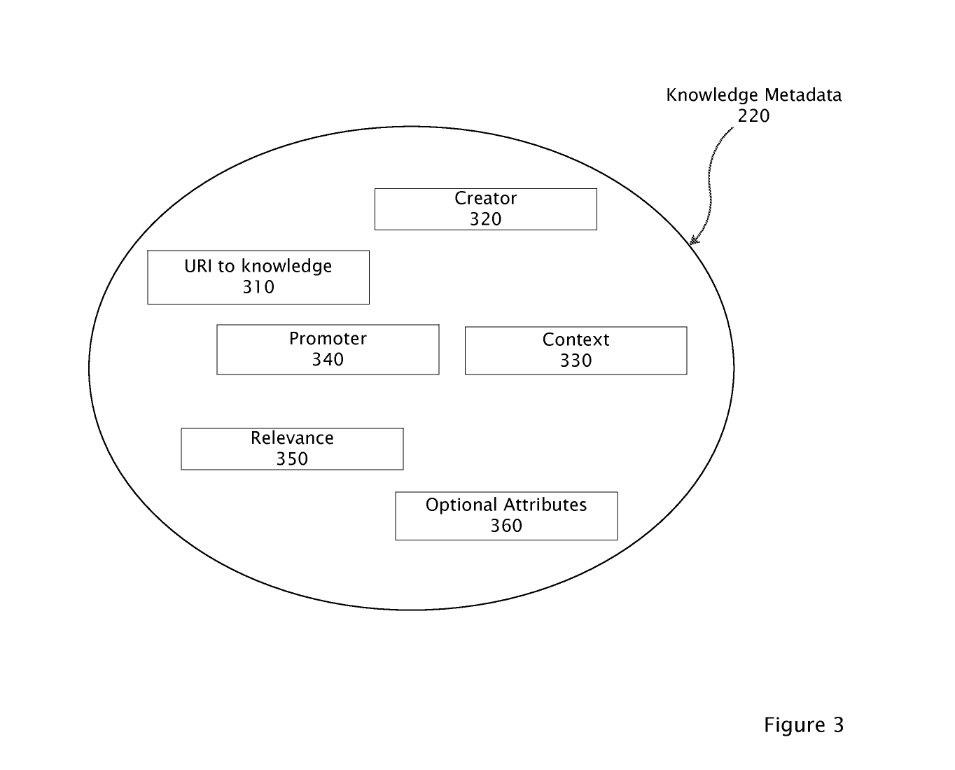

FIG. 3 provides an example of Knowledge Metadata which may be stored in a Social Knowledgebase. Knowledge Metadata 220 may contain various information about an item of knowledge sourced by Sources 205, 206, 207. This meta-knowledge may include attributes that may help indicate the value of the item of knowledge to the user.

Examples of attributes which may be stored in Knowledge Metadata 220 include a URI to the Knowledge 310, a Creator of the knowledge 320, Context 330, a Promoter 340, Relevance 350, and other Option Attributes 360.

URI to Knowledge may be a link to a source of the item of knowledge, for example a web site or a file on a networked computer. Creator 320 may indicate who initially authored the content, or someone who posted the content to the URI. Promoter 340 may track one or more people who promoted the content to knowledge. Relevance 350 may be an indicator of a ranking by listed categories or by user promotion, showing the applicability of the knowledge.

Context 330 may indicate a URI uniquely identifying the item of knowledge's context and content. Having a context for an item of knowledge may help a user understand how relevant it may be to other content the user is reviewing.

Optional Attributes 360 may vary from one set of Knowledge Metadata to another, and may include such information as location, categories, date, or other attributes.

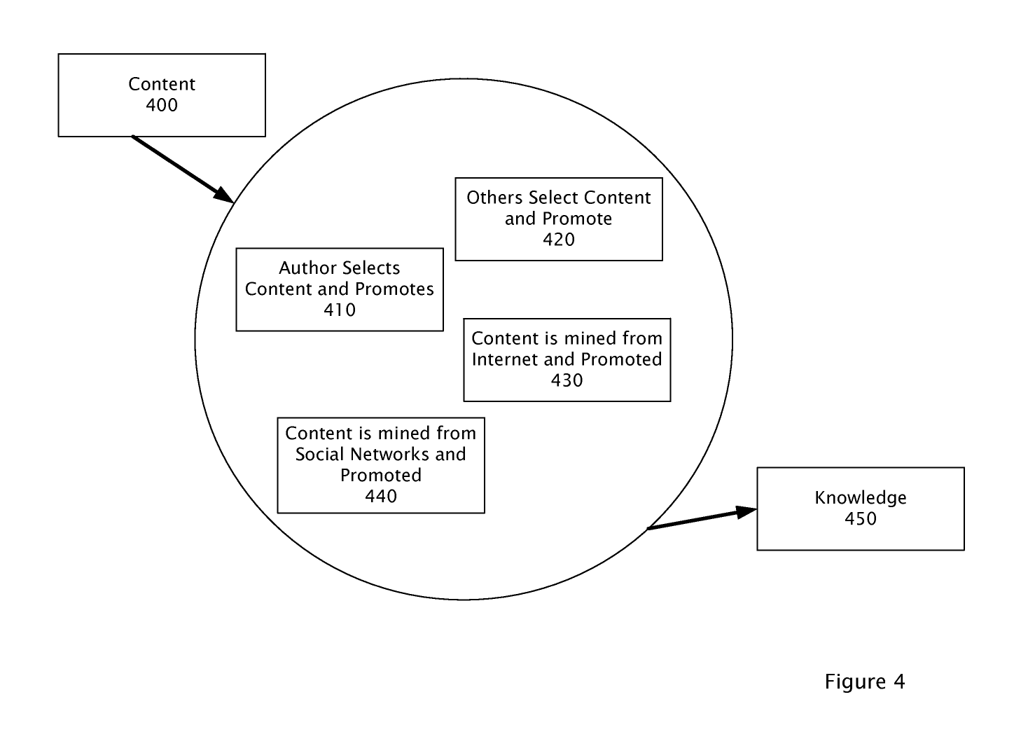

FIG. 4 illustrates how Content 400 may be promoted to Knowledge 450 according to one embodiment.

Content 400 may be text, an image, video, application data, or any form of content. There are several ways Content 400 may be promoted to Knowledge 450. Generally, when content is promoted to knowledge, it may be available to later viewers of similar content. For example, if a user is planning a trip to Norway, knowledge created by people within their social network who have been to Norway before may appear which may increase the sense of trustworthiness for an article being read.

Author Selects Content and Promotes 410 may happen if an author wishes to let consumers of Content 400 that it contains trustworthy information. Others Select Content and Promote 420 may happen if other consumers of Content 400 find that it is trustworthy.

A Social Knowledgebase may also Mine Content from the Internet and Promote it 430. Content 400 may be found to be a source of Knowledge 450 in various ways. A site many users reference, a site that is popular, or other metrics may be used to determine if a site should be promoted. Content Mined from Social Networks and Promoted 440 may also become Knowledge 450. If a user's friends on social networks reference Content 400 often, Content 400 may be a good candidate for Knowledge 450. In an enterprise setting, content may include email and other sources that are maintained on a private virtual network. Email may also be a source in a consumer setting, since information is sometimes exchanged via conversations. Knowledge may thus be surfaced that is private to the user; not just public knowledge. Privacy may be maintained as appropriate.

In another embodiment, a user may become perceived as knowledgeable, either within the user's social network or expanded to outside it. For example, if a user's content is often cited by others, the number of people familiar with the user may grow, so that the user may be considered knowledgeable, or even an expert in some subject areas. In other cases a user may collect knowledge from various sources and thus become known for information about a subject based on content not created by the user.

In yet another embodiment, cultural references may generate additional channels to produce knowledge. For example, James Bond may be associated with particular brands of cars or watches, and that information may be relevant when reading or creating content; such cultural references may augment other knowledge with respect to Aston Martin automobiles, for example.

One having skill in the art will recognize that many different metrics and sources of content may be promoted to knowledge. Once Knowledge 450 is established, it may show up in context as users view or create content. Any knowledge the user has acquired over the years may become a source that shows up in a knowledge context. Knowledge may enhance a reading experience, for example, or may augment research during content creation.

One having skill in the art will recognize that there are many ways Knowledge 450 could be stored and searched, including inverted indexes, relational databases, object databases, or any other way to access multiple items from keywords or other content identification items.

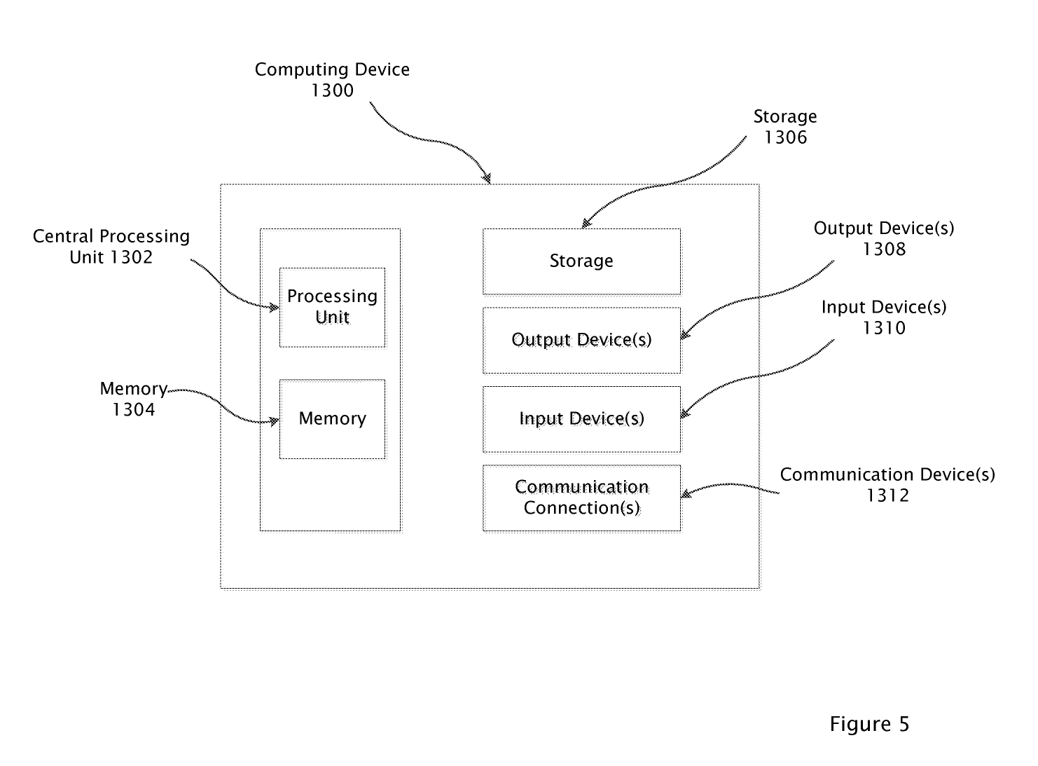

FIG. 5 illustrates a component diagram of a Computing Device according to one embodiment. The Computing Device (1300) can be utilized to implement one or more computing devices, computer processes, or software modules described herein, including, for example, but not limited to User Device 110, 120 or a Content Manager 140. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, 120 or a Content Manager 140. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
a knowledge receiving component, configured to receive knowledge;
a knowledge storing component, configured to store knowledge and knowledge metadata; and
a knowledge retrieval component, configured to retrieve knowledge and knowledge metadata.

2. The system of claim 1, further comprising:
a content receiving component, configured to receive content from a first user device;
a content analyzing component, configured to analyze received content;
a knowledge context recognizing component, configured to recognize relevant knowledge to the analyzed content; and
a knowledge returning component, configured to return relevant knowledge to the first user device.

3. The system of claim 1, further comprising:
a knowledge metadata receiving component, configured to receive metadata about the received knowledge, the metadata including at least one item selected from the group comprising: a universal resource indicator, a creator, a promoter, context, and relevance; and
a knowledge metadata sending component, configured to send metadata about the received knowledge.

4. The system of claim 1 further comprising a content returning component, configured to return knowledge as content in response to a request.

5. The system of claim 1, wherein the knowledge receiving component further comprises:
a user-identifying component, configured to identify a user of the system;
a social feed component, configured to receive content from social networks;
an evaluation component, configured to evaluate the content from social networks; and
a knowledge promotion component, configured to promote content to knowledge based on the evaluation of the content.

6. The system of claim 5, wherein the evaluation component further comprises:
a source-identifying component, configured to identify a promoter who indicates that the content is knowledge; and
a source-evaluation component, configured to evaluate the source based on a perception held by the user of the promoter.

7. The system of claim 5, wherein the evaluation component evaluates content based on a number of citations to that content on the social networks.

8. The system of claim 5, wherein the evaluation component further comprises:
a source-identifying component, configured to identify a promoter who indicates that the content is knowledge; and
a content promotion component, configured to promote the content to knowledge if the promoter is the user.

9. A method, comprising:
receiving an item of content from a first device;
analyzing the item of content;
finding that a first item of knowledge is relevant to the content; and
sending the first item of knowledge to the first device.

10. The method of claim 9, further comprising:
receiving an item of knowledge; and
storing the item of knowledge.

11. The method of claim 9, further comprising:
receiving a request to purchase a second item of knowledge from a second device; and
sending the second item of knowledge to the second device.

12. The method of claim 9 further comprising:
determining relevance of an ad based on context; and
displaying the ad.

13. The method of claim 9, further comprising sending metadata about the knowledge to the device.

14. The method of claim 13, wherein the metadata comprises at least one item selected from the list comprising: a URI to the knowledge, a creator of the knowledge, context of the knowledge, a promoter of the knowledge, and relevance of the knowledge.

15. A computer readable storage media containing instructions thereon which, when executed, instruct a processor to perform a method comprising:
receiving an item of content from a first device;
analyzing the item of content;
finding that an item of knowledge is relevant to the content; and
sending the item of knowledge to the first device.

16. The method of claim 15, further comprising:
receiving an item of knowledge from a second device; and
storing the item of knowledge.

17. The method of claim 15, further comprising sending metadata about the item of knowledge to the first device.

18. The method of claim 17, wherein the metadata comprises at least one item selected from the list comprising: a URI to the knowledge, a creator of the knowledge, context of the knowledge, a promoter of the knowledge, and relevance of the knowledge.

19. The method of claim 15, further comprising:
receiving a request to purchase a second item of knowledge from a third device; and
sending the second item of knowledge to the third device.

20. The method of claim 15 further comprising:
determining relevance of an ad based on context; and
displaying the ad.
